(19) United States
(12) Patent Application Publication
(10) Pub. No.: US 2026/0105182 A1
(43) Pub. Date: Apr. 16, 2026

(54) FEATURE RECOGNITION METHOD AND SYSTEM BASED ON DEEP LEARNING

(71) Applicant: Xiangfu Laboratory, Jiaxing (CN)

(72) Inventors: Haitao Song, Jiaxing (CN); Zikai Wang, Jiaxing (CN); Hao Shen, Jiaxing (CN); Yuechen Liu, Jiaxing (CN); Yuanyuan Lin, Jiaxing (CN); Jingzhe Qian, Jiaxing (CN); Yue Teng, Jiaxing (CN); Guan Huang, Jiaxing (CN); Yuting Yang, Jiaxing (CN); Zihan Feng, Jiaxing (CN); Yiran Xie, Jiaxing (CN); Chengxiang Li, Jiaxing (CN)

(21) Appl. No.: 18/979,425

(22) Filed: Dec. 12, 2024

(30) Foreign Application Priority Data
Oct. 14, 2024 (CN) 2024114334374

(51) Int. Cl. G06F 21/62; G10L 15/02; G10L 15/04; G10L 15/16

(52) U.S. Cl. CPC G06F 21/6245; G10L 15/02; G10L 15/04; G10L 15/16; G10L 2015/025

(57) ABSTRACT

A feature recognition method and system based on deep learning comprises retrieving speech data to be recognized from a database, and obtaining speech data to be recognized. The invention retrieves speech data to be recognized from a database, denoising the data, establishing a character recognition model, inputting denoised speech data to be recognized, automatically recognizing pronunciation of each character in the denoised speech data and translating it into text, obtaining text data and proofreading, obtaining text data after proofreading, analyzing privacy of the speech text data and scoring privacy, comparing privacy scoring with predetermined threshold, determining whether speech text data has an impact on development of an enterprise, and encrypting original speech data and storing it in database to retain evidence and to know who is the informer, which prevents the data from intrusion and destruction of outside, so that system can meet development needs of enterprise.

### 1. TECHNICAL FIELD

The invention belongs to the technical field of feature recognition, specifically relates to a feature recognition method and system based on deep learning.

### 2. BACKGROUND ART

With the development of the mobile Internet, mobile terminal equipment processing power and network bandwidth have been greatly improved, the use of network transmission of voice or video data, network voice calls or video calls and cell phone calls have become a common mode of communication.

At present, in the process of enterprise development, if the speech data generated by network voice calls or video calls and cell phone calls cause the rival company to learn the important confidential information of the enterprise, it will hinder the development of the enterprise, and it is difficult to meet the development needs of the enterprise, and there is a lack of a way to monitor and extract and analyze the speech data of the enterprise in real time and determine whether the speech data is associated with the private data of the enterprise.

### 3. SUMMARY OF THE INVENTION

In order to solve the above technical problem, a feature recognition method and system based on deep learning is provided to solve problems in prior art, namely in the process of enterprise development, if the speech data generated by network voice calls or video calls and cell phone calls cause the rival company to learn the important confidential information of the enterprise, it will hinder the development of the enterprise.

In order to achieve the above purpose, the technical solution adopted in the invention is:
a feature recognition method based on deep learning, comprising:
retrieving speech data to be recognized from a database, and obtaining speech data to be recognized;
denoising the speech data to be recognized, and obtaining denoised speech data to be recognized;
retrieving a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
based on the initials features, finals features, and tone marking features, to constitute a character recognition model;
input the denoised speech data to be recognized into the character recognition model to obtain a speech text data;
perform privacy analysis on the speech text data to obtain privacy scoring;
performing a judgment operation on the original speech data as well as the speech text data based on the privacy scoring of the speech text data.

Preferably, said retrieving the speech data to be recognized from the database and obtaining the speech data to be recognized specifically includes the following steps:
a system automatically marks the recognized speech data with a specific mark and obtains a specific mark marking information;
traversing all the speech data in the database based on the specific mark marking information;
the speech data containing the specific mark marking information is the recognized speech data;
the speech data that does not contain the specific mark marking information is the speech data to be recognized, and the speech data to be recognized is obtained.

Preferably, said denoising the speech data to be recognized, and obtaining denoised speech data to be recognized comprises steps of:
extracting the speech data to be recognized and obtaining a speech signal;
performing a short-time Fourier transform on the speech signal to convert the speech signal to a frequency domain;
in the frequency domain, a filter is used to remove higher frequency noise components and retain the main speech signal;
obtaining parameter information of the original speech data, said parameter information comprising sampling information, quantization information and coding information;
adopting same parameter information to convert the main speech signal to obtain denoised speech data to be recognized.

Preferably, said retrieving the phonetic alphabet string information and the tone marking information of each character in the dictionary from the database, performing feature extraction on the phonetic alphabet string information of each character to obtain a initials feature and a finals feature, and performing feature extraction on the tone marking information of each character to obtain a tone marking feature specifically includes the following steps:
obtaining the phonetic alphabet string information of each character in the dictionary;
based on a initials determination rule and finals determination rule, perform initials and finals feature extraction on the phonetic alphabet string information, and obtain the initials feature and finals feature, said initials determination rule includes a single consonants as initials determination and consonant clusters as initials determination, and said finals determination rule includes a monophthong determination and a compound vowel determination;
obtaining a tone marking information of phonetic alphabet for each character in the dictionary, performing feature extraction on the tone marking information of phonetic alphabet, and obtaining tone marking features.

Preferably, said constituting a character recognition model based on the initials features, finals features, and tone marking features specifically comprises the following steps:
based on a feedforward neural network, constructing a character recognition model; an input data of said character recognition model comprises denoised speech data to be recognized, and an output data is a speech text data;
based on machine learning, marking and dividing said plurality of sample initials features, plurality of sample finals features, and plurality of sample tone marking features to obtain a training set, a validation set, and a test set;
employing said training set, validation set and test set for supervised training, validation and testing of said character recognition model to obtain the character recognition model with an accuracy rate that meets a predetermined accuracy rate requirement.

Preferably, said inputting the denoised speech data to be recognized into the character recognition model to obtain a speech text data specifically comprises steps of:
inputting the denoised speech data to be recognized into said character recognition model which meets the predetermined accuracy rate requirement;
the character recognition model automatically recognizes pronunciation of each character in the denoised speech data and translates it into text to obtain a text data;
retrieving a character grouping information of the dictionary in the database, analyzing and correcting between adjacent words of the text data, and obtaining a corrected speech text data.

Preferably, said performing privacy analysis on the speech text data to obtain privacy scoring specifically includes the following steps:
obtaining a private words model in the database;
performing a weighting analysis on the private words data in the private word model to obtain the private words weights;
performing segmentation processing on the speech text data to obtain each segment of the speech text data;
traversing the private words in the private words model over each segment of the speech text data to obtain the speech text data containing private words of each segment;
based on the private words weights, perform a private words summation operation on each segment of speech text data containing the private words to obtain private words sub-weights of each segment of the speech text data;
performing a summation operation again on the private words sub-weights of each segment of the speech text data to obtain a private words total weight of the speech text data, said private words total weight of the speech text data being the privacy scoring of the speech text data.

Preferably, said performing a judgment operation on the original speech data as well as the speech text data based on the privacy scoring of the speech text data specifically comprises the following steps:
obtaining the privacy scoring of the speech text data, comparing the privacy scoring of the speech text data with a predetermined threshold value, and obtaining a judgment operation;
if the privacy scoring of the speech text data is less than the predetermined threshold, said judgment operation is to destroy both the original speech data and the speech text data;
if the privacy scoring of the speech text data is greater than the predetermined threshold, said judgment operation is to encrypt the original speech data and destroy the speech text data.

Preferably, said performing encryption processing on the original speech data specifically includes the following:
determining length of data bits of the original speech data and obtaining length of a data sequence;
separating the data based on the length of the data sequence, obtaining a plurality of subsequence data of a first predetermined length and a plurality of subsequence data of a second predetermined length, said first predetermined length being smaller than the second predetermined length;
performing a multi-directional messy code operation on a plurality of subsequence data of the first predetermined length and a plurality of subsequence data of the second predetermined length, respectively, both generating a plurality of multi-directional messy code subdata;
performing an irregular permutation and combination of a plurality of multi-directional messy code subdata generated from a plurality of subsequence data of the first predetermined length and a plurality of multi-directional messy code subdata generated from a plurality of subsequence data of the second predetermined length to obtain encrypted data.

The invention also provides a feature recognition system based on deep learning, comprising:
a speech data to be recognized acquisition module, and the speech data to be recognized acquisition module is used to retrieve speech data to be recognized from a database, and obtaining speech data to be recognized;
a denoising module, and the denoising module is used to denoise the speech data to be recognized, and obtaining denoised speech data to be recognized;
a feature extraction module, and the feature extraction module is used to retrieve a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
a character recognition model constitution module, and the character recognition model constitution module is used to constitute a character recognition model based on the initials features, finals features, and tone marking features;
a speech text data acquisition module, and the speech text data acquisition module is used to input the denoised speech data to be recognized into the character recognition model to obtain a speech text data;
a privacy scoring acquisition module, and the privacy scoring acquisition module is used to perform privacy analysis on the speech text data to obtain privacy scoring;
a judgment operation module, and the judgment operation module is used to perform a judgment operation on the original speech data as well as the speech text data based on the privacy scoring of the speech text data.

Compared with the prior art, the invention provides a feature recognition method and system based on deep learning and has the following beneficial effects:
The invention is based on retrieving speech data to be recognized from a database, denoising the data, establishing a character recognition model, inputting the denoised speech data to be recognized, automatically recognizing the pronunciation of each character in the denoised speech data and translating it into text, obtaining text data and proofreading, obtaining text data after proofreading, analyzing the privacy of the speech text data and scoring the privacy, comparing the privacy scoring with a predetermined threshold, determining whether the speech text data has an impact on the development of the enterprise, and encrypting the original speech data and storing it in a database to retain evidence and to know who is the informer, which prevents the data from intrusion and destruction of outside, so that the system can meet development needs of the enterprise.

### 4. BRIEF DESCRIPTION OF ACCOMPANY DRAWINGS

FIG. 1 is a flow chart of a feature recognition method provided by the invention;

FIG. 2 is a flow chart of a method for obtaining speech data to be recognized provided by the invention;

FIG. 3 is a flow chart of a method for obtaining denoised speech data to be recognized provided by the invention;

FIG. 4 is a flow chart of a method for obtaining tone marking features provided by the invention;

FIG. 5 is a flow chart of a method for obtaining a character recognition model provided by the invention;

FIG. 6 is a flow chart of a method for obtaining speech text data provided by the invention;

FIG. 7 is a flow chart of a method for obtaining privacy scoring provided by the invention;

FIG. 8 is a flow chart of a method for performing a judgment operation on the original speech data as well as the speech text data provided by the invention;

FIG. 9 is a flow chart of a method for encrypting the original speech data provided by the invention.

### 5. SPECIFIC EMBODIMENT OF THE INVENTION

The following description is used to disclose the invention in order to enable a person skilled in the art to realize the invention. The preferred embodiments in the following description are intended as examples only, and other obvious variations can be thought of by those skilled in the art.

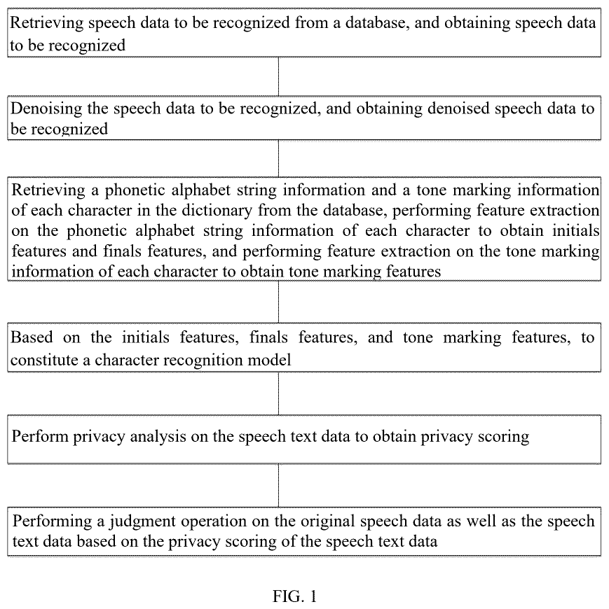

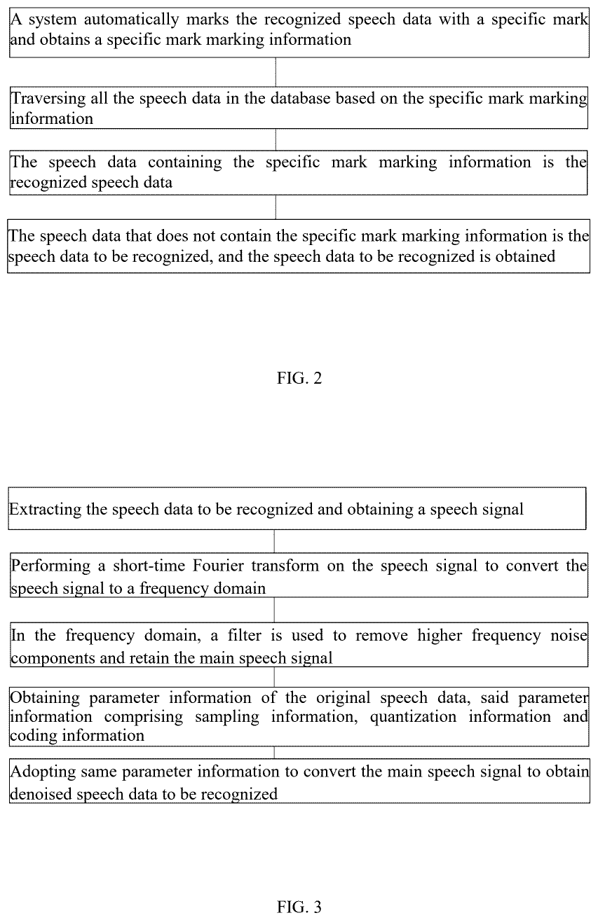

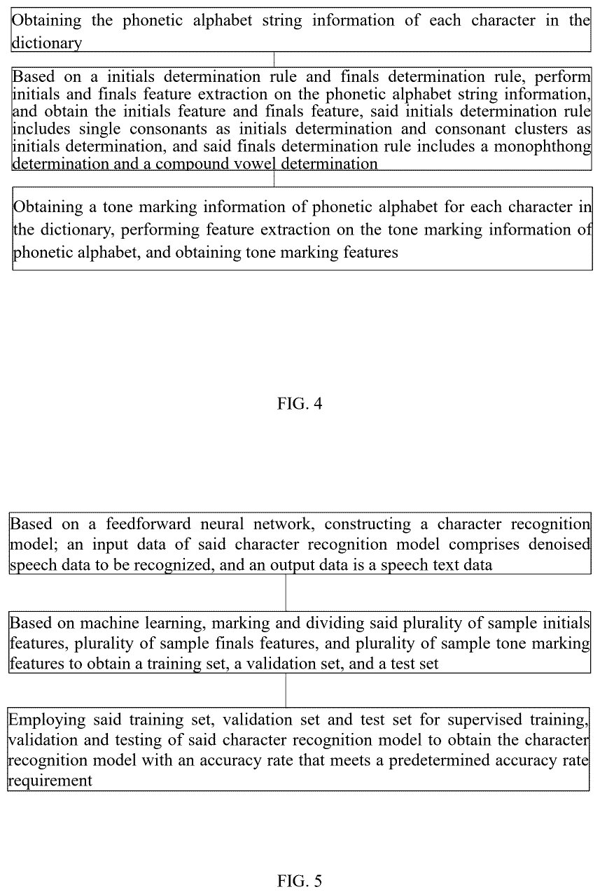

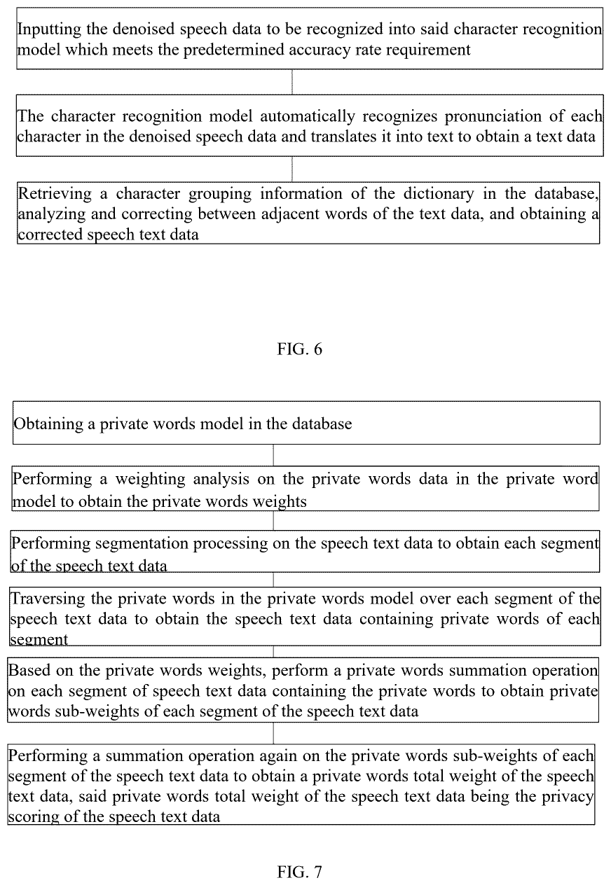

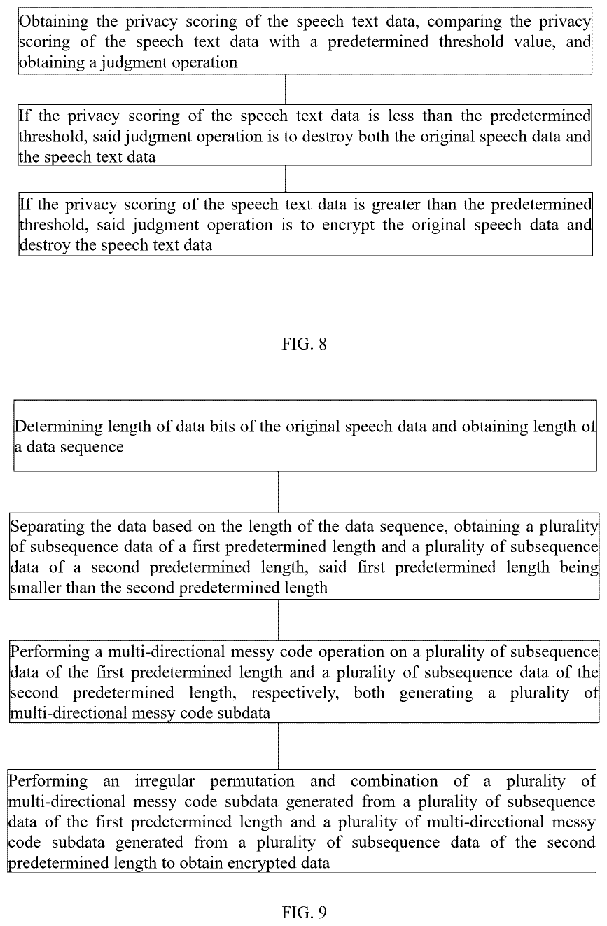

Referring to FIG. 1 to FIG. 9, a feature recognition method based on deep learning, comprising:
retrieving speech data to be recognized from a database, and obtaining speech data to be recognized;
denoising the speech data to be recognized, and obtaining denoised speech data to be recognized;
retrieving a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
based on the initials features, finals features, and tone marking features, to constitute a character recognition model;
input the denoised speech data to be recognized into the character recognition model to obtain a speech text data;
perform privacy analysis on the speech text data to obtain privacy scoring;
performing a judgment operation on the original speech data as well as the speech text data based on the privacy scoring of the speech text data.

It is understood by those in the art that the telephone calls of the internal personnel of the enterprise are recorded, and the telephone calls here include cell phone calls, voice calls, video calls and so on, and all the recorded data are stored in a database, and the speech data to be recognized is extracted from the database; since there is noise interference in the telephone recordings, in order not to affect subsequent processing of the data, it is necessary to carry out denoising processing of the speech data to be recognized; since each character has a phonetic alphabet string information and corresponding tones of the phonetic alphabet, and there are four tones, and the phonetic alphabet string information consists of initials and finals, therefore, the character recognition model can be built after analyzing the features of initials, finals, and tone markings in the dictionary; the character recognition model can simulate the pronunciation of the character, and then the denoised speech data to be recognized can be input into the character recognition model, which can then translate each character in the speech data to form corresponding speech text data; further, the speech text data is analyzed to see whether the text therein relates to confidential and private information of the enterprise, and then carry out a judgement operation on the data.

Said retrieving the speech data to be recognized from the database and obtaining the speech data to be recognized specifically includes the following steps:
a system automatically marks the recognized speech data with a specific mark and obtains a specific mark marking information;
traversing all the speech data in the database based on the specific mark marking information;
the speech data containing the specific mark marking information is the recognized speech data;
the speech data that does not contain the specific mark marking information is the speech data to be recognized, and the speech data to be recognized is obtained.

It is understood by those skilled in the art that there exists specific mark markings in the system, such as “recognized”, and when the data is recognized, the data is automatically marked with “recognized”, and there are recognized data and data to be recognized stored in the database; using “recognized” to traverse all the data in the whole database, the data containing “recognized” must be recognized speech data, while the data not carrying “recognized” must be speech data to be recognized.

Said denoising the speech data to be recognized, and obtaining denoised speech data to be recognized comprises steps of:
extracting the speech data to be recognized and obtaining a speech signal;
performing a short-time Fourier transform on the speech signal to convert the speech signal to a frequency domain;
in the frequency domain, a filter is used to remove higher frequency noise components and retain the main speech signal;
obtaining parameter information of the original speech data, said parameter information comprising sampling information, quantization information and coding information;
adopting same parameter information to convert the main speech signal to obtain denoised speech data to be recognized.

It is understood by those in the art that denoising the speech signal not only enhances clarity of the speech, but also reduces size of the data and accelerates subsequent processing of data by the system, and the speech signal after removing the noise also needs to be digitally converted, and it is worth noting here that the parameter information of the original speech data is obtained, and the same parameter information is used for the equivalent conversion, to ensure data authenticity, which will not cause errors in the subsequent data processing.

Said retrieving the phonetic alphabet string information and the tone marking information of each character in the dictionary from the database, performing feature extraction on the phonetic alphabet string information of each character to obtain a initials feature and a finals feature, and performing feature extraction on the tone marking information of each character to obtain a tone marking feature specifically includes the following steps:
obtaining the phonetic alphabet string information of each character in the dictionary;
based on a initials determination rule and finals determination rule, perform initials and finals feature extraction on the phonetic alphabet string information, and obtain the initials feature and finals feature, said initials determination rule includes single consonants as initials determination and consonant clusters as initials determination, and said finals determination rule includes a monophthong determination and a compound vowel determination;
obtaining a tone marking information of phonetic alphabet for each character in the dictionary, performing feature extraction on the tone marking information of phonetic alphabet, and obtaining tone marking features.

It is understood by those in the art that single consonants as initials determination includes: b, p, m, f, d, t, n, l, g, k, h, j, q, x, zh, ch, sh, r, z, c, s, which letters will be regarded as initials when a syllable begins with any one of the above and is not a final; the consonant clusters as initials determination includes: zh, ch, sh, r, z, c, s, when a syllable begins with any two or more of the above and is not a final, these letters will be regarded as finals. And the monophthong determination includes: a, o, e, i, u, ü, when a syllable contains any one of the above monophthong, these letters will be regarded as finals; and the compound vowel determination includes: ai, ei, ui, ao, ou, iu, ie, üe, er, when a syllable contains any two letters of the above, these letters will be regarded as finals. And there are four kinds of tone markings, including: level tone ( ), rising tone (\acute{ }), falling-rising tone ( ̆) and falling tone (\grave{ }).

Said constituting a character recognition model based on the initials features, finals features, and tone marking features specifically comprises the following steps:
based on a feedforward neural network, constructing a character recognition model; an input data of said character recognition model comprises denoised speech data to be recognized, and an output data is a speech text data;
based on machine learning, marking and dividing said plurality of sample initials features, plurality of sample finals features, and plurality of sample tone marking features to obtain a training set, a validation set, and a test set;
employing said training set, validation set and test set for supervised training, validation and testing of said character recognition model to obtain the character recognition model with an accuracy rate that meets a predetermined accuracy rate requirement.

As may be understood by those skilled in the art, the feedforward neural network is a type of artificial neural network that uses a unidirectional multilayer structure, in which layer 0 is called an input layer, a last layer is called an output layer, and other intermediate layers are called hidden layers, and the hidden layers can be either one layer or multiple layers, and each hidden layer contains a plurality of neurons, and each neuron can receive signals from the neuron of the previous layer and produce an output to the next layer; there is no feedback in the network, and the signal propagates unidirectionally from the input layer to the output layer. A plurality of sample initials features, a plurality of sample finals features, and a plurality of sample tone marking features are used as construction data, the construction data are randomly divided into a training set, a validation set, and a test set according to a certain ratio, and the divided training set, validation set, and test set are marked, and exemplarily, the present application preferably has a ratio of 8:1:1, wherein the training set is used to train the model, i.e., to determine weights of the model and bias for these learning parameters; the validation set is used to validate each model using the validation set data after a plurality of models have been trained by the training set, and to record the model accuracy, and thus to select the model with the best results and its corresponding parameters; the test set is used only once, i.e., when evaluating the final model after the completion of the training, and is neither involved in the process of learning parameters nor in the process of hyper-parameter selection but is used only in conjunction with model evaluation. Based on machine learning, supervised training of the model is carried out by means of the training set, the obtained model is verified by means of the validation set, the trained model is evaluated by means of the test set, and the hyper-parameters are continuously adjusted until the accuracy rate meets the predetermined requirements, and output the speech text data.

Said inputting the denoised speech data to be recognized into the character recognition model to obtain a speech text data specifically comprises steps of:
inputting the denoised speech data to be recognized into said character recognition model which meets the predetermined accuracy rate requirement;
the character recognition model automatically recognizes pronunciation of each character in the denoised speech data and translates it into text to obtain a text data;
retrieving a character grouping information of the dictionary in the database, analyzing and correcting between adjacent words of the text data, and obtaining a corrected speech text data.

It is understood by those skilled in the art that the “dictionary” of the invention is not only the common Xinhua dictionary in life, but also includes some popular network vocabulary in today's society, some professional terminology vocabulary within the enterprise, etc., which covers a wide range of words because the same pronunciation can be output in different fonts, and neighboring words can be composed of different words, so it is necessary to compare and analyze the words to improve the accuracy of the translated words, and also improve the accuracy of the subsequent privacy analysis.

Said performing privacy analysis on the speech text data to obtain privacy scoring specifically includes the following steps:
obtaining a private words model in the database;
performing a weighting analysis on the private words data in the private word model to obtain the private words weights;
performing segmentation processing on the speech text data to obtain each segment of the speech text data;
traversing the private words in the private words model over each segment of the speech text data to obtain the speech text data containing private words of each segment;
based on the private words weights, perform a private words summation operation on each segment of speech text data containing the private words to obtain private words sub-weights of each segment of the speech text data;
performing a summation operation again on the private words sub-weights of each segment of the speech text data to obtain a private words total weight of the speech text data, said private words total weight of the speech text data being the privacy scoring of the speech text data.

It is understood by by those skilled in the art that an enterprise corresponds to different private words data at different stages of development, such as including project private words data at different stages, private words data of competitor companies at different stages, etc., and these private words data constitutes a private words model, and different private words data has different weights and different impacts on the enterprise, for example, when it comes to a competitor inquiring about the enterprise's bidding situation, the weight is larger, and the impact on the development of the enterprise is also larger, so the speech text data is segmented, and then the private words in the private words model traverses each segment of the speech text data, which makes size of each segment of the speech text data become smaller, improves the speed of data processing, and thus obtains each segment of the speech text data that contain the private words; as an example, a speech text data is divided into three segments, in which the first segment contains a private word, the weight of which is 50, then the sub-weight of the private words scoring of the first segment is 50, the second segment contains two private words, the weights of which are 50 and 60 respectively, then the sub-weight of the private words scoring of the second segment is 50+60 as 110, and the third segment contains three private words, the weights of which are 50, 60 and 70 respectively, then the sub-weight of the private words scoring of the third segment is 50+60+70 as 180, and finally the total weight of private words is 50+110+180 as 340, and 340 is the privacy scoring.

Said performing a judgment operation on the original speech data as well as the speech text data based on the privacy scoring of the speech text data specifically comprises the following steps:
obtaining the privacy scoring of the speech text data, comparing the privacy scoring of the speech text data with a predetermined threshold value, and obtaining a judgment operation;
if the privacy scoring of the speech text data is less than the predetermined threshold, said judgment operation is to destroy both the original speech data and the speech text data;
if the privacy scoring of the speech text data is greater than the predetermined threshold, said judgment operation is to encrypt the original speech data and destroy the speech text data.

It is understood by those skilled in the art that if the privacy scoring of the speech text data is less than the predetermined threshold value, it means that privacy of the speech text data is low, and there is no need to exist in the database, and the original speech data as well as the speech text data can be directly destroyed, expanding the space in which the database can be stored; and if the privacy scoring is greater than the predetermined threshold value, then it means that the privacy is greater, and that the data can't be known by the outside world, then the original speech data is encrypted and stored in the database; if this speech data causes the rival enterprise to learn the important secrets of the enterprise, the subsequent risk to the enterprise, so the original voice data is stored in the database to retain the evidence to learn who is the informer, and the original speech data is encrypted, which further improves the security of the data and prevents the outside world from invading and destroying the data.

Said performing encryption processing on the original speech data specifically includes the following:
determining length of data bits of the original speech data and obtaining length of a data sequence;
separating the data based on the length of the data sequence, obtaining a plurality of subsequence data of a first predetermined length and a plurality of subsequence data of a second predetermined length, said first predetermined length being smaller than the second predetermined length;
performing a first multi-directional messy code operation on a plurality of subsequence data of the first predetermined length to generate a plurality of first multi-directional multi-directional messy code subdata;
performing a second multi-directional messy code operation on a plurality of subsequence data of the second predetermined length, respectively to generate a plurality of second multi-directional messy code subdata;
performing an irregular permutation and combination based on a plurality of first multi-directional messy code subdata and a plurality of second multi-directional messy code subdata to obtain encrypted data.

It can be understood by those skilled in the art that the data is separated into a plurality of subsequence data of a first predetermined length and a plurality of subsequence data of a second predetermined length, and performing a multi-directional scrambling operation on a plurality of subsequence data of the first predetermined length and a plurality of subsequence data of the second predetermined length, respectively, then irregular permutation and combination are carried out subsequently. The values of the first predetermined length and the second predetermined length of the initial separation are randomized, as well as the multi-directional scrambling is also randomized, and the irregular permutation and combination are also randomized, so as to realize encryption of the data and ensure security of the data, and the external invasion cannot violently damage the data.

The invention also provides a feature recognition system based on deep learning, comprising:
a speech data to be recognized acquisition module, and the speech data to be recognized acquisition module is used to retrieve speech data to be recognized from a database, and obtaining speech data to be recognized;
a denoising module, and the denoising module is used to denoise the speech data to be recognized, and obtaining denoised speech data to be recognized;
a feature extraction module, and the feature extraction module is used to retrieve a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
a character recognition model constitution module, and the character recognition model constitution module is used to constitute a character recognition model based on the initials features, finals features, and tone marking features;
a speech text data acquisition module, and the speech text data acquisition module is used to input the denoised speech data to be recognized into the character recognition model to obtain a speech text data;
a privacy scoring acquisition module, and the privacy scoring acquisition module is used to perform privacy analysis on the speech text data to obtain privacy scoring;
a judgment operation module, and the judgment operation module is used to perform a judgment operation on the original speech data as well as the speech text data based on the privacy scoring of the speech text data.

The invention is based on retrieving speech data to be recognized from a database, denoising the data, establishing a character recognition model, inputting the denoised speech data to be recognized, automatically recognizing the pronunciation of each character in the denoised speech data and translating it into text, obtaining text data and proofreading, obtaining text data after proofreading, analyzing the privacy of the speech text data and scoring the privacy, comparing the privacy scoring with a predetermined threshold, determining whether the speech text data has an impact on the development of the enterprise, and encrypting the original speech data and storing it in a database in order to retain evidence and to know who is the informer, which prevents the data from intrusion and destruction of outside, so that the system can meet development needs of the enterprise.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A feature recognition method based on deep learning, comprising:
retrieving speech data to be recognized from a database, and obtaining speech data to be recognized;
denoising the speech data to be recognized, and obtaining denoised speech data to be recognized;
retrieving a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
based on the initials features, finals features, and tone marking features, to constitute a character recognition model;
input the denoised speech data to be recognized into the character recognition model to obtain a speech text data;
perform privacy analysis on the speech text data to obtain privacy scoring;
performing a judgment operation on the original speech data as well as the speech text data based on the privacy scoring of the speech text data.

2. The feature recognition method based on deep learning of claim 1, wherein said retrieving the speech data to be recognized from the database and obtaining the speech data to be recognized specifically includes the following steps:
a system automatically marks the recognized speech data with a specific mark and obtains a specific mark marking information;
traversing all the speech data in the database based on the specific mark marking information;
the speech data containing the specific mark marking information is the recognized speech data;
the speech data that does not contain the specific mark marking information is the speech data to be recognized, and the speech data to be recognized is obtained.

3. The feature recognition method based on deep learning of claim 2, wherein said denoising the speech data to be recognized, and obtaining denoised speech data to be recognized comprises steps of:
extracting the speech data to be recognized and obtaining a speech signal;
performing a short-time Fourier transform on the speech signal to convert the speech signal to a frequency domain;
in the frequency domain, a filter is used to remove higher frequency noise components and retain the main speech signal;
obtaining parameter information of the original speech data, said parameter information comprising sampling information, quantization information and coding information;
adopting same parameter information to convert the main speech signal to obtain denoised speech data to be recognized.

4. The feature recognition method based on deep learning of claim 3, wherein said retrieving the phonetic alphabet string information and the tone marking information of each character in the dictionary from the database, performing feature extraction on the phonetic alphabet string information of each character to obtain a initials feature and a finals feature, and performing feature extraction on the tone marking information of each character to obtain a tone marking feature specifically includes the following steps:
obtaining the phonetic alphabet string information of each character in the dictionary;
based on a initials determination rule and finals determination rule, perform initials and finals feature extraction on the phonetic alphabet string information, and obtain the initials feature and finals feature, said initials determination rule includes a single consonants as initials determination and consonant clusters as initials determination, and said finals determination rule includes a monophthong determination and a compound vowel determination;
obtaining a tone marking information of phonetic alphabet for each character in the dictionary, performing feature extraction on the tone marking information of phonetic alphabet, and obtaining tone marking features.

5. The feature recognition method based on deep learning of claim 4, wherein said constituting a character recognition model based on the initials features, finals features, and tone marking features specifically comprises the following steps:
based on a feedforward neural network, constructing a character recognition model; an input data of said character recognition model comprises denoised speech data to be recognized, and an output data is a speech text data;
based on machine learning, marking and dividing said plurality of sample initials features, plurality of sample finals features, and plurality of sample tone marking features to obtain a training set, a validation set, and a test set;
employing said training set, validation set and test set for supervised training, validation and testing of said character recognition model to obtain the character recognition model with an accuracy rate that meets a predetermined accuracy rate requirement.

6. The feature recognition method based on deep learning of claim 5, wherein said inputting the denoised speech data to be recognized into the character recognition model to obtain a speech text data specifically comprises steps of:
inputting the denoised speech data to be recognized into said character recognition model which meets the predetermined accuracy rate requirement;
the character recognition model automatically recognizes pronunciation of each character in the denoised speech data and translates it into text to obtain a text data;
retrieving a character grouping information of the dictionary in the database, analyzing and correcting between adjacent words of the text data, and obtaining a corrected speech text data.

7. The feature recognition method based on deep learning of claim 6, wherein said performing privacy analysis on the speech text data to obtain privacy scoring specifically includes the following steps:
obtaining a private words model in the database;
performing a weighting analysis on the private words data in the private word model to obtain the private words weights;
performing segmentation processing on the speech text data to obtain each segment of the speech text data;
traversing the private words in the private words model over each segment of the speech text data to obtain the speech text data containing private words of each segment;
based on the private words weights, perform a private words summation operation on each segment of speech text data containing the private words to obtain private words sub-weights of each segment of the speech text data;
performing a summation operation again on the private words sub-weights of each segment of the speech text data to obtain a private words total weight of the speech text data, said private words total weight of the speech text data being the privacy scoring of the speech text data.

8. The feature recognition method based on deep learning of claim 7, wherein said performing a judgment operation on the original speech data as well as the speech text data based on the privacy scoring of the speech text data specifically comprises the following steps:
obtaining the privacy scoring of the speech text data, comparing the privacy scoring of the speech text data with a predetermined threshold value, and obtaining a judgment operation;
if the privacy scoring of the speech text data is less than the predetermined threshold, said judgment operation is to destroy both the original speech data and the speech text data;
if the privacy scoring of the speech text data is greater than the predetermined threshold, said judgment operation is to encrypt the original speech data and destroy the speech text data.

9. The feature recognition method based on deep learning of claim 8, wherein said performing encryption processing on the original speech data specifically includes the following:
determining length of data bits of the original speech data and obtaining length of a data sequence;
separating the data based on the length of the data sequence, obtaining a plurality of subsequence data of a first predetermined length and a plurality of subsequence data of a second predetermined length, said first predetermined length being smaller than the second predetermined length;
performing a multi-directional messy code operation on a plurality of subsequence data of the first predetermined length and a plurality of subsequence data of the second predetermined length, respectively, both generating a plurality of multi-directional messy code subdata;
performing an irregular permutation and combination of a plurality of multi-directional messy code subdata generated from a plurality of subsequence data of the first predetermined length and a plurality of multi-directional messy code subdata generated from a plurality of subsequence data of the second predetermined length to obtain encrypted data.

10. A feature recognition system based on deep learning, used to realize the feature recognition method based on deep learning of claim 1, comprising:
a speech data to be recognized acquisition module, and the speech data to be recognized acquisition module is used to retrieve speech data to be recognized from a database, and obtaining speech data to be recognized;
a denoising module, and the denoising module is used to denoise the speech data to be recognized, and obtaining denoised speech data to be recognized;
a feature extraction module, and the feature extraction module is used to retrieve a phonetic alphabet string information and a tone marking information of each character in the dictionary from the database, performing feature extraction on the phonetic alphabet string information of each character to obtain initials features and finals features, and performing feature extraction on the tone marking information of each character to obtain tone marking features;
a character recognition model constitution module, and the character recognition model constitution module is used to constitute a character recognition model based on the initials features, finals features, and tone marking features;
a speech text data acquisition module, and the speech text data acquisition module is used to input the denoised speech data to be recognized into the character recognition model to obtain a speech text data;
a privacy scoring acquisition module, and the privacy scoring acquisition module is used to perform privacy analysis on the speech text data to obtain privacy scoring;
a judgment operation module, and the judgment operation module is used to perform a judgment operation on the original speech data as well as the speech text data based on the privacy scoring of the speech text data.
